(19) United States
(12) Patent Application Publication
(10) Pub. No.: US 2026/0248321 A1
(43) Pub. Date: Aug. 27, 2026

(54) APPLIANCE FOR PRODUCING BEVERAGES, PREFERABLY FOAMED MILK OR MILK BEVERAGES

(71) Applicant: STEINER AG WEGGIS, Weggis (CH)

(72) Inventor: Adrian Steiner, Weggis (CH)

(73) Assignee: STEINER AG WEGGIS, Weggis (CH)

(21) Appl. No.: 19/644,015

(22) Filed: Apr. 10, 2026

Related U.S. Application Data
(62) Division of application No. 17/753,991, filed on Sep. 10, 2020.

(30) Foreign Application Priority Data
Oct. 14, 2019 (CH) 01308/19

(51) Int. Cl. A47J 31/46; A23L 2/54

(52) U.S. Cl. CPC A47J 31/469; A23L 2/54

(57) ABSTRACT

Apparatus for producing beverages, preferably foamed milk or milk beverages, in which milk is sucked up out of a container by a pump through at least one line and is conveyed through the at least one line to an outlet. Preferably, multiple different flavored liquids can be supplied as desired from a respective vessel at least individually into the line for conveying the milk. In this manner, the flavored liquid is mixed in already during production of the milk beverage, with the result that a high degree of mixing and thus the desired flavor is optimally achieved.

### CROSS REFERENCE TO RELATED APPLICATION

This application is a divisional of U.S. patent application Ser. No. 17/753,991 filed Mar. 21, 2022, which is incorporated by reference herein.

### FIELD OF THE INVENTION

The invention relates to an apparatus or appliance that produces beverages, preferably foamed milk or milk beverages, with which milk is sucked out of a container by means of a pump through at least one line, and is conveyed through this line to an outlet. The appliance is preferably integrated in a coffee machine or in a separate milk unit.

### BACKGROUND OF THE INVENTION

With known coffee machines of this type, the milk sucked out of the container is processed in a cold or hot state, or processed to form cold or hot foamed milk, and then discharged into a cup or the like. In addition, flavor liquids can be added to the beverage which has been produced, in that they are held in a replaceable manner in or next to the coffee machine, and are conveyed through hoses to an outlet next to the milk outlet and into the cup or the like. There they are mixed into the beverage in a cup or the like. This, however, does not provide a uniform and thoroughly mixed beverage.

The flavored liquids which are mixed in are usually syrups with an aroma of vanilla, chocolate, fruits such as raspberry, strawberry, or similar substances. It is also possible, however, for alcoholic flavor liquids to be used, such as for Irish Coffee or the like.

### OBJECTS AND SUMMARY OF THE INVENTION

The invention is based on the object of avoiding these disadvantages, and providing a method and apparatus, by means of which the preparation of aromatized milk beverages is simplified, and in this situation an optimum mixing of the flavor liquid in the beverage is guaranteed.

The object is solved according to the invention in that, preferably, multiple different flavor liquids can be supplied as desired from a respective vessel, at least individually, through at least one feed line into the line for conveying the milk.

In this way, the mixing of the flavor liquid takes place already at the production of the milk beverage in the appliance, which is integrated in a coffee machine or a separate milk unit, the consequence of which is that a high degree of mixing and thus the desired flavor is optimally achieved.

Advantageously, the flavor liquid is added to the milk upstream of the inlet opening of the air delivery line into the milk conveying line. It is therefore possible, with this arrangement, for uniform milk beverages, with or without foamed milk, to be optimally mixed with the desired flavor.

With the use of a steam line as a heating device for the milk, opening into the milk conveying line, the invention makes provision for the flavor liquid to be added to the beverage upstream of the inlet opening of the steam line into the milk conveying line, and this is therefore also optimally achieved, since in this way the flavor liquid is likewise heated, or, if cold milk or cold foamed milk is being produced, it remains in a cold state.

As an alternative, however, provision can be made for the flavor liquid to be added to the beverage downstream of the inlet opening of the steam line in the milk conveying line, but upstream of the outlet of the beverage out of the coffee machine. This could be advantageous in order to achieve a foamed milk of better consistency.

The invention likewise makes provision for the coffee machine to be provided with preferably four different flavor liquid vessels, which can be connected via a common connection part to the milk conveying line, with four inlets and with a non-return valve preventing the flow of milk or foamed milk into the vessels. By selective opening and closing of the inlets, the beverage can be provided with the respective flavor.

As a further advantage, the method according to the invention makes provision for the flavor liquid, if required, also to be conveyed without milk through the milk conveying line into the cup or the like, in order for it to be conveyed separately to the beverage which has already been produced, such as to allow for a decorative figure to be produced on the surface of the foamed milk.

### BRIEF DESCRIPTION OF THE DRAWINGS

The invention is described in greater detail hereinafter on the basis of exemplary embodiments, making reference to the drawings, wherein:

FIG. 1 is a hydraulic schematic of an appliance according to the invention, and

FIG. 2 is a perspective view of a connection sleeve at the inlet of the flavor liquid into the milk conveying line of the appliance according to FIG. 1.

### DETAILED DESCRIPTION OF THE INVENTION

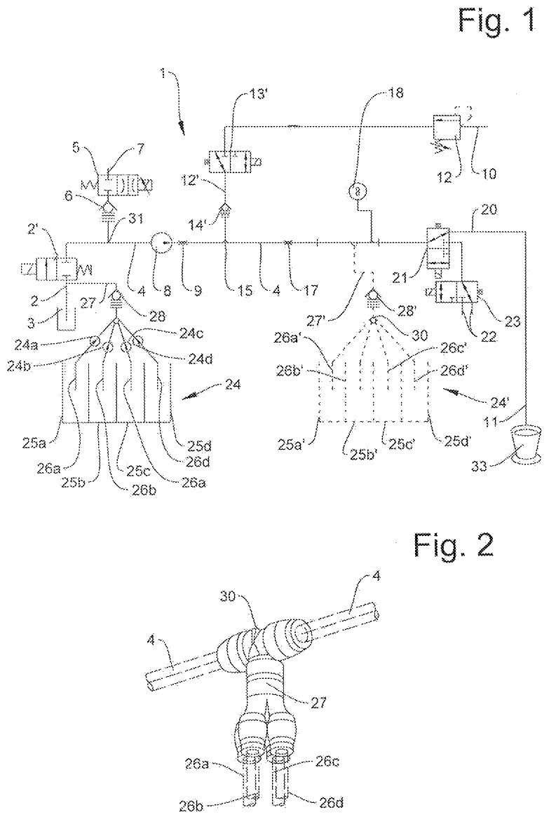

The appliance shown in FIG. 1 contains a milk container 3, with a line 2, which can be connected, as a suction hose with a two-way valve 2′, to the line 4. The milk container 3 could also consist of several part containers with different types of milk. In principle, this two-way valve 2′ could be provided with a through-hole choke, such that, regardless of the filling level in the container 3, approximately the same quantity of milk would be sucked up.

The appliance 1 also contains an air supply line 7, which can be connected to the intake opening 31 of the line 4 via a switchable control valve 5 and a non-return valve 6 for preparing the foamed milk. In addition, a controllable pump 8 is arranged in the line 4, with which the milk is sucked out of the milk container 3 and is conveyed to an outlet 11. Located in the line 4 downstream of the pump 8, configured, for example, as a gear pump, are preferably two choke points 9, 17, in order to achieve a swirling effect on the milk or the milk/air mixture.

Following this is a heating device for heating the milk or the foamed milk, which consists of a steam delivery line 10 with a pressure equalizing valve 12, and, following this, at least one steam line 12′, which opens into the line 4 via a slide valve or opening valve 13′ and a non-return valve 14′. Downstream of its inlet opening 15, the line 4 contains a further choke 17 for slowing or swirling the milk or foamed milk, which is provided optionally.

At the line 4, an outlet line 20 connects to an outlet 11 for the milk beverage which has been produced, for filling a cup 33 or the like. A two-way valve 21 serves, on the one hand, to let the milk or foamed milk through to the outlet 11, and, on the other hand, interacts with a conventional cleaning circuit, of which a feed line and discharge line 22 are shown, with a cleaning valve 23 which can be switched on or off.

In addition, at least one thermostat 18 is integrated in the line 4 for measuring the temperature of the milk or foamed milk. With this, by means of a regulating arrangement, a controlled production of foamed milk can be achieved in a known manner, which is not explained in any greater detail. In principle, it would also be possible for a measuring device to be integrated in the line 4, in order to determine the consistency of the foamed milk which is to be prepared.

According to the invention, a feed device 24 is contained in the appliance 1, in particular for producing aromatized milk beverages from several vessels 25a to 25d, which during operation are filled with flavor liquids. In each vessel is a flavor liquid, each with a different aroma or all with the same aroma.

With the exemplary embodiment described, the device is provided with four vessels. Within the framework of the invention, it is also possible, however, depending on the requirement, for fewer or more than four vessels to be provided. These vessels are advantageously located in an exchangeable manner in the device 1, such that, after emptying, they can be replaced with new vessels

As has already been mentioned heretofore, suitable as flavor liquids are, in particular, syrups with an aroma of vanilla, chocolate, fruits such as raspberries, strawberries, bananas, or similar substances, or also alcoholic flavor liquids.

The liquids in the vessels 25a to 25d can be selectively sucked up and conveyed by means of individual lines 26a to 26d, by the pump 8 and/or each by way of conveying means 24a, 24b, 24c, 24d into the common feed line 27, with a non-return valve 28, directly into the line 2, in which the respective flavor liquid which has been selected is mixed with the milk. The inlet opening of the feed line 27 into the line 2 is located between the milk container 3 and the two-way valve 2′, i.e., upstream of the pump 8 sucking the milk, and upstream of the inlet opening 31 of the air feed line 7. In this way, as desired, either milk or foamed milk beverages are produced with the flavor of the flavor liquid which has been selected.

These conveying means 24a, 24b, 24c, 24d can also simply be controllable valves, of which one or more would open when the respective flavor liquid is introduced, such that the liquid would be sucked up by the pump 8.

Moreover, shown in FIG. 1 is also an appliance 24′, represented by a broken line, which could be provided instead of or in addition to the appliance 24. With this, the connection into the line 4 is placed downstream of the connection 15 of the steam line 12′. To connect the vessels 25a′ to 25d′ into the line 4, a feed line 27′ with a non-return valve 28′ is provided.

These appliances 24 and 24′ provide the same advantages in respect of the possibility of producing both cold as well as hot aromatized milk and foamed milk beverages. Only the degree of mixing between the milk or foamed milk and the flavor liquid which has been selected in the respective case can vary somewhat if appropriate.

The appliance 24, 24′ according to the invention, which can be integrated in a coffee machine or in a separate unit, is characterized by a very compact structural form, which allows for a selective choice to be made by selection buttons on the operating display. It also has the advantage that it hardly influences the overall structure of the appliance as far as the outlet.

FIG. 2 further shows another variant of a connection sleeve 30 of the feed appliance 24, which connects the lines 25a to 25d and the feed line 27 into the line 4. Such a connection can therefore be installed very easily.

The invention is adequately described by the exemplary embodiments explained heretofore. It may also be explained by further variants. For example, instead of the one feed line 27 leading into the milk line, it would also be possible for each line 26a, 26b, 26c, 26d to lead directly into this milk line.

Instead of the conveying means 24a, 24b, 24c, 24d, which also have the effect of a closure valve, it would be possible, as mentioned, for closure valves to be provided, such that, when selecting a specific flavor liquid, the corresponding closure valve is opened and the specific single conveying means is switched on, and therefore the corresponding flavor liquid would be conveyed into the milk line. It would also be possible for more than one flavor liquid to be introduced simultaneously.

It would also be possible for a flow-type heater or the like to be provided as the heating appliance, which would be integrated in a known manner in the line 4 of the milk conveying system.

Accordingly, disclosed above is an apparatus for producing beverages, preferably milk-based beverages, that includes a line configured to be connected to a milk-containing container, a pump configured to draw milk out of the milk-containing container into the one line and convey the drawn milk through the one line to an outlet;, and which may be the only pump associated with the one line and which acts to convey the milk and additives thereto, and a feed device through which the one line passes, entering the feed device and exiting the feed device. The feed device includes, in addition to the one line passing therethrough, a first feed line that opens into the one line, and which first feed line is coupled to a plurality of individual feed lines, each of configured to be connected to a respective one of a plurality of flavored liquid-containing containers.

In one embodiment, that shown in FIG. 1, the feed device is situated prior to the pump in a flow direction. The one line includes an intake opening 31 prior to the pump 8 and after the feed device in the flow direction. An air supply system includes an air feed line for supplying air through the intake opening into the one line. A choke point 9 in the one line is after the pump in the flow direction.

In some embodiments, a heating device heats fluid in the one line, e.g., the milk and its additives. For example, the one line can include an inlet opening 15 after the pump 8 in the flow direction, and the heating device includes at least one steam line through which steam is conveyed into the one line through the inlet opening. A choke point 17 may be in the one line after the inlet opening in the flow direction. Additionally, or alternatively, the feed device may be situated after the inlet opening in the flow direction.

In one embodiment, the apparatus includes a plurality of valves each associated with a respective one of the plurality of feed lines to regulate flow through the respective one of the plurality of feed lines.

The pump may be configured to draw at least one of a plurality of different flavor liquids from a respective one of the plurality of flavored liquid-containing containers and convey the at least one drawn different flavor liquid into the one line such that the same pump that is configured to draw milk out of the milk-containing container into the one line also draws the at least one of the plurality of different flavor liquids into the one line. The first feed line may be the only feed line of the feed device that opens into the one line, and is different than the one line.

The feed device may include a plurality of conveying means each associated with a respective one of the plurality of individual feed lines and configured to convey a respective one of a plurality of different flavor liquids from a respective one of the plurality of flavored liquid-containing containers into the first feed line.

A milk-based beverage machine, generally including the above apparatus, would include a milk-containing container configured to contain milk, a plurality of flavored liquid-containing containers each configured to contain a respective one of a plurality of different flavor liquids, a line connected to the milk-containing container, a pump configured to draw milk out of the milk-containing container into the one line and convey the drawn milk through the one line to an outlet, and the feed device as in any of the above-described configurations.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. Apparatus for producing beverages, comprising:
a line configured to be connected to a milk-containing container;
a pump configured to draw milk out of the milk-containing container into said one line and convey the drawn milk through said one line to an outlet; and
a feed device through which said one line passes, said feed device comprising a first feed line that opens into said one line, said first feed line being coupled to a plurality of individual feed lines, each of said plurality of individual feed lines being configured to be connected to a respective one of a plurality of flavored liquid-containing containers.

2. The apparatus of claim 1, wherein said feed device is situated prior to said pump in a flow direction.

3. The apparatus of claim 2, wherein said one line comprises an intake opening prior to said pump and after said feed device in the flow direction, the apparatus further comprising an air supply system including an air feed line for supplying air through said intake opening into said one line.

4. The apparatus of claim 3, further comprising a choke point in said one line after said pump in the flow direction.

5. The apparatus of claim 1, further comprising a heating device for heating fluid in said one line.

6. The apparatus of claim 5, wherein said one line comprises an inlet opening after said pump in the flow direction, and wherein said heating device comprises at least one steam line through which steam is conveyed into said one line through said inlet opening.

7. The apparatus of claim 6, further comprising a choke point in said one line after said inlet opening in the flow direction.

8. The apparatus of claim 6, wherein said feed device is situated after said inlet opening in the flow direction.

9. The apparatus of claim 1, further comprising a plurality of valves each associated with a respective one of said plurality of feed lines to regulate flow through the respective one of said plurality of feed lines.

10. The apparatus of claim 1, wherein said pump is further configured to draw at least one of a plurality of different flavor liquids from a respective one of said plurality of flavored liquid-containing containers and convey the at least one drawn different flavor liquid into said one line such that the same pump that is configured to draw milk out of the milk-containing container into said one line also draws the at least one of the plurality of different flavor liquids into said one line.

11. The apparatus of claim 1, wherein said first feed line is the only feed line of said feed device that opens into said one line, and is different than said one line.

12. The apparatus of claim 1, wherein said feed device further comprises a plurality of conveying means each associated with a respective one of said plurality of individual feed lines and configured to convey a respective one of a plurality of different flavor liquids from a respective one of said plurality of flavored liquid-containing containers into said first feed line.

13. The apparatus of claim 12, wherein said first feed line is the only feed line of said feed device that opens into said one line, and is different than said one line.

14. The apparatus of claim 1, further comprising a non-return valve in said first feed line.

15. A milk-based beverage machine, comprising:
a milk-containing container configured to contain milk;
a plurality of flavored liquid-containing containers each configured to contain a respective one of a plurality of different flavor liquids;
a line connected to said milk-containing container;
a pump configured to draw milk out of said milk-containing container into said one line and convey the drawn milk through said one line to an outlet; and
a feed device through which said one line passes, said feed device comprising a first feed line that opens into said one line, said first feed line being coupled to a plurality of individual feed lines, each of said plurality of individual feed lines being connected to a respective one of said plurality of flavored liquid-containing containers.

16. The machine of claim 15, wherein said feed device is situated prior to said pump in a flow direction.

17. The machine of claim 16, wherein said one line comprises an intake opening prior to said pump and after said feed device in the flow direction and an inlet opening after said pump in the flow direction, the apparatus further comprising an air supply system including an air feed line for supplying air through said intake opening into said one line, and a heating device for heating fluid in said one line and which comprises at least one steam line through which steam is conveyed into said one line through said inlet opening.

18. The machine of claim 15, wherein said pump is further configured to draw at least one of the plurality of different flavor liquids from a respective one of said plurality of flavored liquid-containing containers and convey the at least one drawn different flavor liquid into said one line such that the same pump that is configured to draw milk out of said milk-containing container into said one line also draws the at least one of the plurality of different flavor liquids into said one line.

19. The machine of claim 15, wherein said first feed line is the only feed line of said feed device that opens into said one line, and is different than said one line.

20. The machine of claim 15, wherein said first feed line is the only feed line of said feed device that opens into said one line, and is different than said one line, and wherein said feed device further comprises a plurality of conveying means each associated with a respective one of said plurality of individual feed lines and configured to convey a respective one of the plurality of different flavor liquids from a respective one of said plurality of flavored liquid-containing containers into said first feed line.
